(19) United States
(12) Patent Application Publication
(10) Pub. No.: US 2023/0421092 A1
(43) Pub. Date: Dec. 28, 2023

(54) SUPPORT FOR ROOF-MOUNTED PHOTOVOLTAIC PANEL

(71) Applicant: Emerson CORDEIRO DE OLIVEIRA, Campo Grande (BR)

(72) Inventor: Emerson CORDEIRO DE OLIVEIRA, Campo Grande (BR)

(21) Appl. No.: 18/252,954

(22) PCT Filed: Sep. 13, 2021
(86) PCT No.: PCT/BR2021/050391

§ 371 Date: May 15, 2023

(30) Foreign Application Priority Data
Sep. 15, 2020 (BR) 102020018812-7

(51) Int. Cl. H02S 20/25

(52) U.S. Cl. CPC H02S 20/25

(57) ABSTRACT

The SUPPORT FOR ROOF-MOUNTED PHOTOVOLTAIC PANEL, relates to a support used for fixing a plurality of photovoltaic panels for generating solar energy directly on the tiles of an existing roof. The support is suitable for fixation on the high portion of the tile, which provides the best angle for capturing solar rays, thereby increasing energy generation efficiency. Furthermore, it is easy and practical to install, highly durable and lightweight, making it suitable for installation on the vast majority of existing roofs.

### SUBJECT

The present Invention patent refers to a support used for fixing a plurality of photovoltaic panels for the generation of solar energy directly onto the tiles of an existing roof. The support is suitable for fixation at the high portion of the tile, which provides the best angle for capturing solar rays, increasing the efficiency in energy generation. In addition, it features easy and practical installation, high durability, and a lightweight design, making it well-suited for use on the majority of existing roofs.

### DESCRIPTION OF PRIOR ART

The search for sustainable energy generation alternatives is an ongoing pursuit, motivated by the pressing need to preserve the environment and, more importantly, to reduce our dependence on fossil fuels.

While solar energy generation through photovoltaic panels is a well-established technology, fixing them onto existing roofs typically requires structural reinforcements, often in the form of an additional structure to support the panels. This construction requirement can sometimes render installation technically or economically unfeasible, resulting in an unsatisfactory cost-benefit ratio and discouraging the implementation of many projects.

As an alternative to said extra structure, the use of tiles that have a built-in photovoltaic panel is also a known option. This solution can be found in document BR 102013004092-4, filed on 13 Feb. 2013 by SILVA, which describes a photovoltaic energy-generating tile, and also in document BR 202012022836-5, filed on Nov. 9, 2012 by CLARISTONI, which presents a plastic photovoltaic tile. However, in both cases, the previous roof must be removed for the installation of the photovoltaic tiles, generating additional costs for their installation.

The document BR 202016019758-4, filed on Aug. 25, 2016, by the same applicant, describes a sustainable polymer base with antioxidant, flame retardant, and ultraviolet additives. The base is shaped to fit in the lower portion of the tile, between its high ridges, and is designed to support a plurality of photovoltaic panels. In this case, there is no need to drill or displace the tiles to install the panels, which could result in damage to the roof. Instead, the panels are fixed directly onto the polymeric base, which ensures a secure installation without compromising the integrity of the tiles.

Nonetheless, while this solution allows for easy installation of photovoltaic panels on existing roofs, it only utilizes the available area on the low ridges, which does not allow for optimal positioning of the panels to generate energy efficiently.

These drawbacks ultimately restrict the installation of this solution on roofs where the tiles have small low wave portions or in locations that are not conducive to optimal sunlight capture.

### INVENTIVE CONCEPT

The present Support for Roof-mounted Photovoltaic Panel was primarily developed to achieve the following objectives:
Allow for the installation of photovoltaic panels using a support placed on the high portion of existing roof tiles.
Allow for the use of almost the entire area of the existing roof for capturing solar rays.
Enable better positioning of photovoltaic panels with respect to the angle of incidence of the sun, thereby increasing efficiency.
Enable easy and practical installation on various models of roof tiles in existing residential, industrial, or commercial buildings.
Provide high durability as it is manufactured using sustainable polymer with antioxidant, UV-resistant, and fire-resistant additives, featuring male and female fittings equipped with an expansion joint.

To this end, the solution comprises a support structure with a lower portion that matches the shape of the high part of the wave of the tile, whether it is curved, trapezoidal, or another shape. On this lower portion, a straight quadrangular base with internal rails is attached, allowing for easy installation of the photovoltaic panels. The rails are situated at three of the four corners, ensuring secure placement of the panels.

The support is manufactured from sustainable polymer with antioxidant, fire-resistant, and UV-resistant additives, reducing the heat absorption generated by the roof tiles and transmitted to the photovoltaic panel. The supports feature male-type fittings that enable their installation along the length of the roof tile. Additionally, they have expansion joints that allow easy absorption of natural expansions and contractions of the roof tile due to temperature changes without damaging or transferring the movement to the photovoltaic panels. Although it is not the preferred construction, the support could alternatively be made from aluminum, which would guarantee the same characteristics of lightness, efficiency, and durability.

The panels feature a tempered glass surface layer, preferably self-cleaning and available in colorless or colored options, ensuring greater safety for the photovoltaic cells and enhancing their durability. Alternatively, the tempered glass layer can be replaced by polymer sheets, preferably acrylic sheets, available in clear or colored options.

This solution has been designed to be installed on various types of existing roofs, making it a practical, efficient, and lightweight option. Its purpose is to promote the widespread adoption of this economically advantageous and environmentally significant solution.

### FIELD OF APPLICATION

The application of the present Support for Roof-mounted Photovoltaic Panel is as a support structure for photovoltaic modules specially adapted for roof structures or roof coverings.

### ADVANTAGES

The advantages of the Support for Roof-mounted Photovoltaic Panel are:
Allows for easy installation of photovoltaic panels on existing roofs, due to the male and female fitting system. This eliminates the need to replace the existing roof tiles or build an additional support structure for the photovoltaic panels.
Enables installation on various styles of tiles without requiring additional support for the placement of the solar panels.
Due to the fact that the polymer base is made of sustainable polymer with antioxidant, fire-resistant, and UV-resistant additives, it boasts high durability and low heat transmission rate.
Alternatively, the base can be made of aluminum, ensuring the same durability characteristics.
The fact that the photovoltaic panels are fixed on the high ridge of existing tiles, combined with the sustainable polymer base with antioxidant, fire-retardant, and UV-resistant additives, results in lower transmission of heat from the roof to the panels, thereby increasing their efficiency.
Due to the same reason, there is an increase in the area for capturing solar rays as well as an improved positioning with regard to inclination, resulting in increased efficiency of the overall system.
The polymeric supports are designed with expansion joints, which allow the units to expand and contract according to temperature changes without damaging the photovoltaic panels.
Empowers the reduction of electricity generation costs and its installation in a broad range of existing structures, including residential, commercial, industrial, and other buildings.
Enables the widespread installation of the photovoltaic modules under various technical and economic conditions.
Empowers the reduction of non-renewable energy usage, thus decreasing carbon emissions generated by the combustion of coal.
Offers flexibility in usage, as the tempered glass, polymer or acrylic sheet used to protect against hailstorms can be colorless or colored, combined with the colors of the supports and combined with the colors of the roof.

### FIGURES

In order to facilitate research and provide understanding of the present patent, as set forth in the present description, according to a basic and preferred embodiment developed by the applicant, reference is made to the attached illustrations, which are an integral part of and support this patent specifications, wherein:

FIG. 01—presents the support perspective.

FIG. 02—presents the exploded perspective of the support.

FIG. 03—presents the perspective of multiple supports applied on the tile.

FIG. 04—presents the perspective of the support with a variation of the base.

FIG. 05—presents the exploded perspective of a variation of the photovoltaic panel fixation.

FIG. 06—presents a perspective view of a variation in the photovoltaic panel fixation.

FIG. 07—presents a front view of the support.

FIG. 08—presents a front view of a second variation of the support base.

FIG. 09—presents a front view of a third variation of the support base.

FIG. 10—presents a top view of the support.

FIG. 11—presents a bottom view of the support.

FIG. 12—presents a perspective view of a constructive variant of the support.

FIG. 13—presents an exploded perspective view of a constructive variant of the support.

FIG. 14—presents a perspective view of a constructive variant of the support applied on a tile.

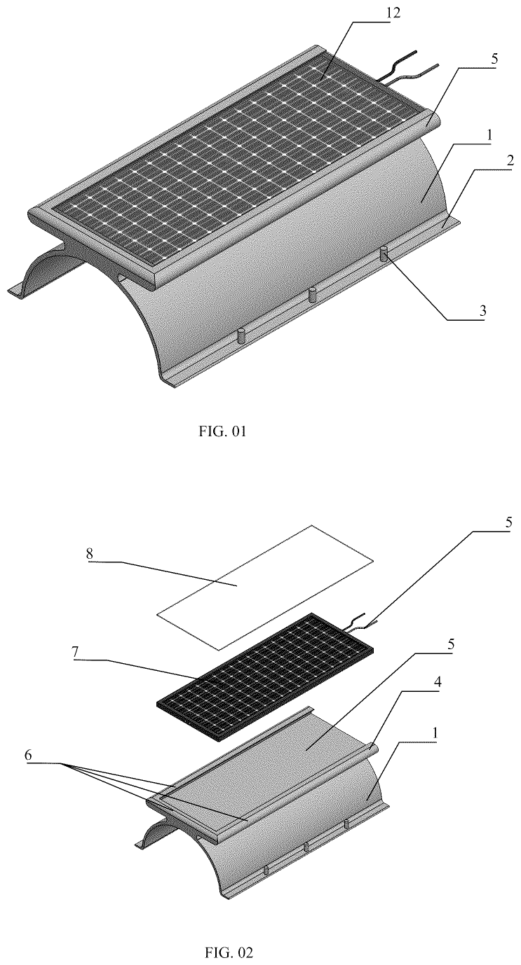

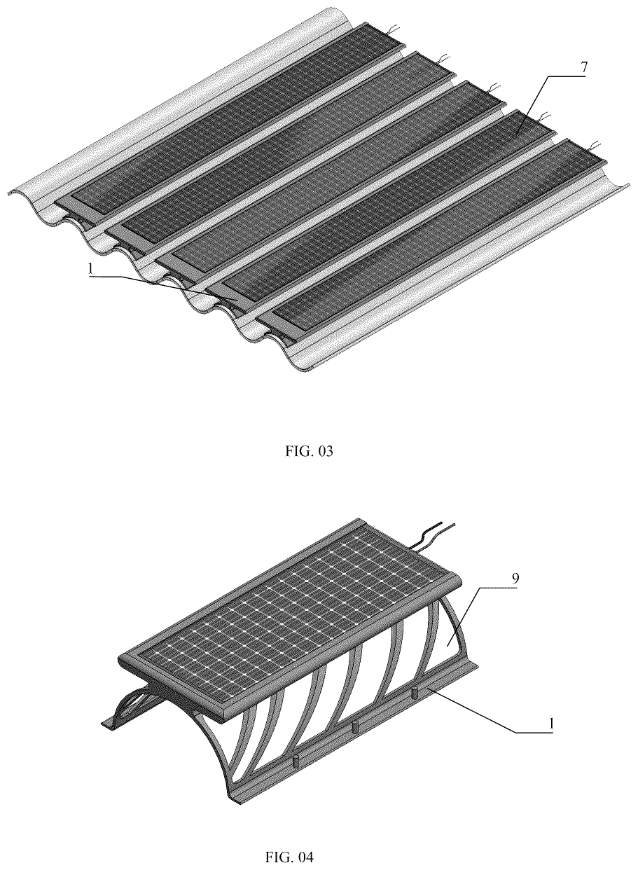

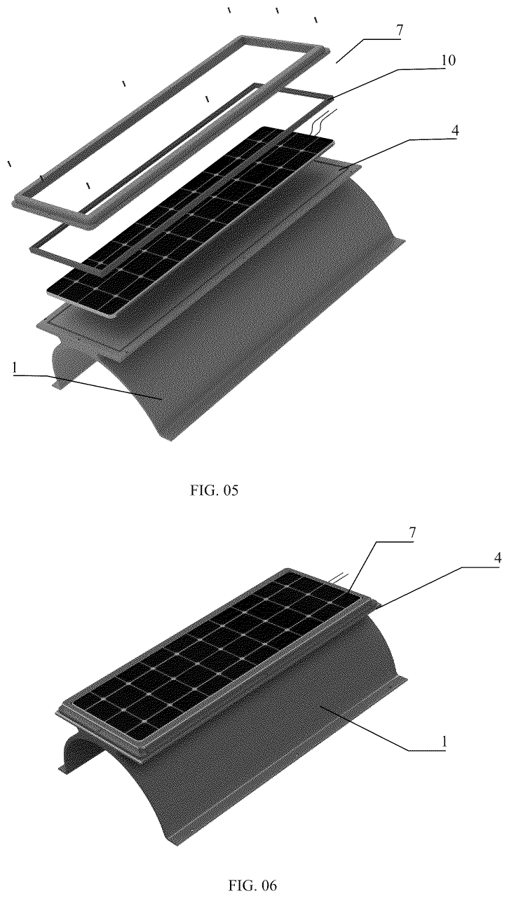

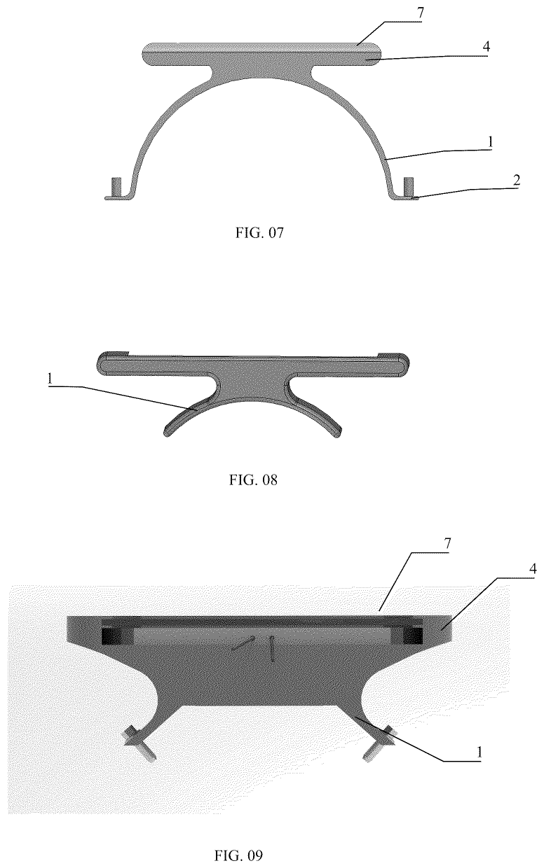

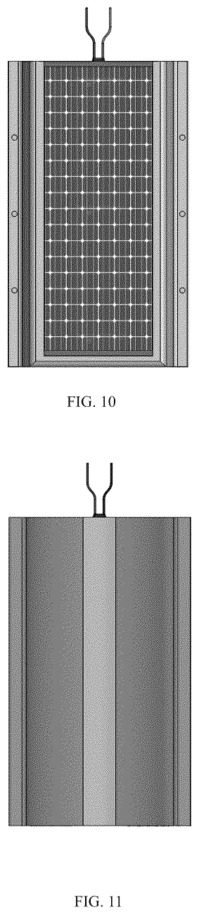

### DESCRIPTION

The Support for Roof-mounted Photovoltaic Panel is composed of the curved base (1) that must have the same shape as the high portion of the tile where it will be applied, with side flaps (2) that will serve that will serve to place the fixing pins (3) on the tile. Alternatively, the fixation by the pins (3) can be replaced by fixation by glue or similar material.

Superiorly, the curved base (1) has a straight base (4) that includes a central portion (5) and lateral rails (6) that are used to attach the photovoltaic panel (7) with a surface layer (8).

The side rails (6) act as drawers promote the easy placement and removal of the photovoltaic panel (7), which also includes wires (8) for connection between the panels or with the local power grid to allow transmission of the energy generated by the panel.

The support is typically made of polymeric material, preferably PVDF (Polyvinylidene Fluoride), with additives that provide them with mechanical strength and UV resistance. The intense coloration, along with the anti-UV additive, makes the pieces serve as decorative pieces on the roof, matching its color. The intense and durable colors are achieved by adding pigment concentrate of the masterbatch-type in a ratio of 1% to 5% in thermoplastic resin, which is then processed through injection or extrusion.

In addition, other additives are used to ensure that the floor base has the necessary strength and durability to withstand prolonged exposure to adverse weather conditions, without compromising the integrity of the circuits and fittings of the photovoltaic panels. Such additives may include:
Desiccant additive: absorbs moisture from the polymer, reducing the time required during the production process of the object.
Antioxidant additive: protects the polymer from thermo-oxidative degradation during the process.
Auxiliary flow additive: provides greater productivity, reduces and/or eliminates material buildup in the manufacturing matrix, and improves the surface characteristics of the object.
Anti-static additive: neutralizes static electricity, preventing the accumulation of dust on the piece.
Flame retardant additive: modifies the fire behavior in different polymer blends, delays ignition, and reduces burning speed and smoke formation;
Antimicrobial additive: prevents the growth of fungi and bacteria.
Antifibrillating additive: helps stabilize the production process;
Expanding agent additives: reduces the weight of the piece, helps with thermal and acoustic insulation.
Purging agent additive: helps with the cleaning of machines (such as injectors, extruders, etc.) with time and material savings in production.

The photovoltaic panel (7) comprises one or more photovoltaic cells of the (P) and (N) types, which comprise a crystalline silicon structure coated with a conductive film of a dopant solution with natural or synthetic polymers. The dopant solutions of the (P) and (N) types comprise components in nanoparticle form of carotenoids such as beta-carotene, canthaxanthin, bixin, norbixin, lycopene, fucoxanthin, and others extracted from natural sources such as annatto, tomato, watermelon, guava, corn, carrot, pumpkin, seaweed, and various other natural sources.

Synthetic antioxidant and ultraviolet dopant components can also be used for solar protection, causing a decrease in the thermal coefficient and, consequently, an increase in the efficiency of the electrical conductivity of these cells.

The components used in the composition of photovoltaic cells are crystalline silicon, phosphorus, calcium, colophony resin, fluorocarbon cationic surfactant, liquid glycerin, silver nitrate, crystal polycarbonate film with ultraviolet filter, or ethylene vinyl acetate (EVA) polymer, a layer of glass or translucent resin with ultraviolet protection additive. This is done to provide efficient solar protection for decreasing the thermal coefficient and, consequently, increasing the efficiency in the conductivity of photovoltaic cells. Other formulations can also be used in the final composition of encapsulated photovoltaic cells, without limiting the invention of other photovoltaic cell products already existing in the global market.

Over the encapsulated and integrated photovoltaic cell in the panel (7), a layer of transparent surface material (8) is fitted to enable the capture of solar rays by the cells. This material contains anti-reflective components, as well as high-impact mechanical resistance, anti-adherent properties to prevent excessive dirt buildup, and anti-slip properties for safe use.

One material that can meet all of these requirements is self-cleaning tempered glass. This type of glass is infused with nanoparticles of silica and polymers, creating a protective layer that gives it self-cleaning properties, high transparency, and anti-reflection. The high transparency of this self-cleaning tempered glass can improve energy capture efficiency by more than 3%.

In some cases, there may be male and female fittings between the photovoltaic panels (7), allowing for linear placement along the roof tiles with integrated operation.

Alternatively, the curved base (1) may include a plurality of hollow elements (9), which make the support even lighter and transmit even less heat to the photovoltaic panel (7).

As a variation of the photovoltaic panel fixing, the photovoltaic plate (7) is fixed by screws directly on the straight base (4), using a sealing rubber (10).

As an alternative, the curved base (1) can take on other tile shapes, such as high and low curves, trapezoidal, calhetão, or other tile models.

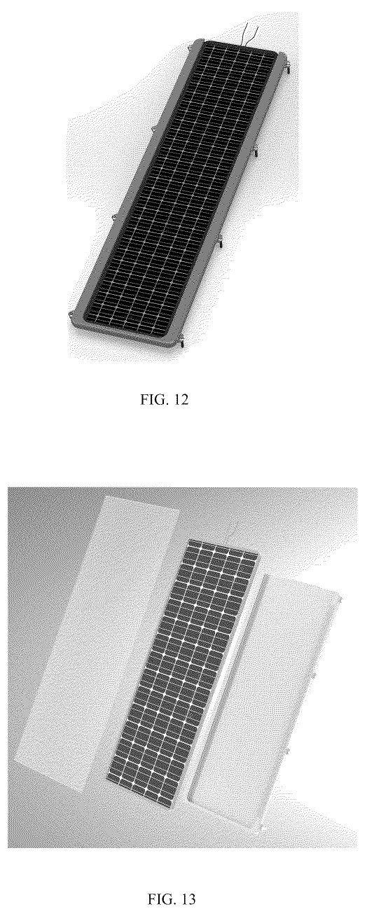

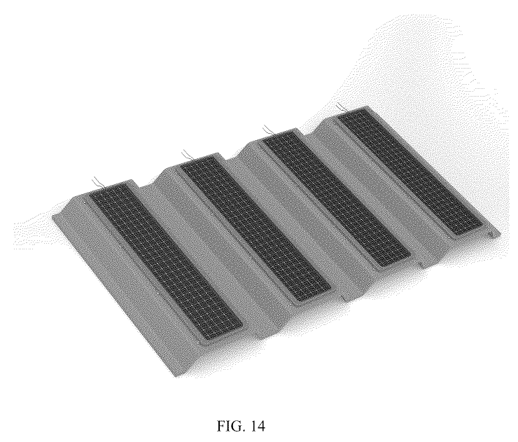

In a constructive variant, the support can be shaped only by the straight base (4) that includes a central portion (5) and lateral rails (6) that are used to attach the photovoltaic panel (7) with a surface layer (8), as shown in FIGS. 12 to 14.

In this case, the panel is attached to the roof using screws or rivets, or by an adhesive product directly onto the upper flat part of the tile, when its format allows it.

### CONCLUSION

In conclusion, the Support for Roof-mounted Photovoltaic Panel is subsidized by unprecedented functional characteristics, thus deserving the claimed legal protection.

1. SUPPORT FOR ROOF-MOUNTED PHOTOVOLTAIC PANEL is characterized by the fact that the curved base (1) has the same shape as the high portion of the tile where it will be applied.

2. SUPPORT FOR ROOF-MOUNTED PHOTOVOLTAIC PANEL according to claim 1 is characterized by the curved base (1) being equipped with side flaps (2) for placing the fixing pins (3) on the tile.

3. SUPPORT FOR ROOF-MOUNTED PHOTOVOLTAIC PANEL according to claim 2 is characterized by the fact that fixation on the tile is achieved by adhesive means.

4. SUPPORT FOR ROOF-MOUNTED PHOTOVOLTAIC PANEL according to claim 1 is characterized by the curved base (1) having the straight base (4) which includes a central portion (5) and side rails (6) to attach the photovoltaic panel (7) equipped with a surface layer (8).

5. SUPPORT FOR ROOF-MOUNTED PHOTOVOLTAIC PANEL according to claim 4 is characterized by the photovoltaic panel (7) being alternatively secured by screws directly onto the straight base (4), using a sealing rubber (10).

6. SUPPORT FOR ROOF-MOUNTED PHOTOVOLTAIC PANEL according to claim 1 is characterized by the curved base (1) being made of polymeric material, preferably PVDF (Polyvinylidene Fluoride), containing additives that provide mechanical and UV resistance.

7. SUPPORT FOR ROOF-MOUNTED PHOTOVOLTAIC PANEL according to claim 6 is characterized by the additives being of the desiccant, antioxidant, flow aid, antistatic, flame retardant, antimicrobial, antifibrillating, expanding agent, and purging agent types.

8. SUPPORT FOR ROOF-MOUNTED PHOTOVOLTAIC PANEL according to claim 1 is characterized by the surface layer (8) of the photovoltaic panel (7) being transparent, self-cleaning, and anti-reflective.

9. SUPPORT FOR ROOF-MOUNTED PHOTOVOLTAIC PANEL according to claim 1, is characterized by the curved base (1) alternatively containing hollow elements (9).

10. SUPPORT FOR ROOF-MOUNTED PHOTOVOLTAIC PANEL according to claim 1, is characterized by the curved base (1) alternatively containing hollow elements (9).

11. SUPPORT FOR ROOF-MOUNTED PHOTOVOLTAIC PANEL is characterized by the support being shaped by the straight base (4) which includes a central portion (5) and side rails (6) to attach the photovoltaic panel (7) with a surface layer (8).

12. SUPPORT FOR ROOF-MOUNTED PHOTOVOLTAIC PANEL according to claim 11 is characterized by the support being fixed by screws or adhesive means on the flat face of the tile.
